(19) United States
(12) Patent Application Publication
(10) Pub. No.: US 2003/0173699 A1
(43) Pub. Date: Sep. 18, 2003

(54) Hole forming plug

(76) Inventor: Kenneth McLean, Burlington (CA)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/230,823

(22) Filed: Aug. 29, 2002

(30) Foreign Application Priority Data
Mar. 14, 2002 (CA) 2376531

(51) Int. Cl. B28B 1/48

(52) U.S. Cl. 264/154; 249/175

(57) ABSTRACT

A mold plug for use in a mold, the mold being used in a rotary concrete casting process to make a cast article, the mold plug comprising: a rigid internal core having an internal engagement means to secure the plug in the mold during casting and to facilitate removal of the plug from the cast article after casting is complete; and a pliable external cover on the internal core, the external cover having a surface adapted to not bond with concrete, and having a predetermined size and shape, wherein, when the mold plug is removed from the cast article after the casting is complete, a hole of a predetermined size and shape is left in the cast article.

### FIELD OF THE INVENTION

This invention relates to the general field of cast articles such as concrete poles, and more particularly to devices used during manufacturing of cast articles such as concrete poles.

### BACKGROUND OF THE INVENTION

Utility poles used to provide street lighting are a common roadside sight. The poles are often made of concrete due to the strength, long term durability, and weather resistance of the material. The poles are generally hollow, having concrete walls of a certain thickness and a hollow core containing electrical wiring to power a light fixture located near the top of the pole.

A number of holes of varying sizes are constructed in the walls of the pole to allow for the electrical power connection from the utility company and for other purposes. In particular, it is often desired to create a series of holes over a substantial part of the height of the pole so that they will be available if needed at a future time. The alternative, involving drilling holes as needed in the finished pole, is generally unacceptable because of the risk that the drill will hit and break the internal steel skeleton used to support the pole structure. The pre-formed holes penetrate the concrete walls, providing access to the hollow core, and are usually created as pairs 180 degrees apart. This arrangement allows a straight bar or rod to be pushed through the pole, forming a stable platform on which various devices such as transformers can be mounted. Another application is to attach guy wires to the platform, to help stabilize utility poles located in an area with high cross-winds. Typically, the holes used for this application are circular and small, about 1-2″ in diameter, since their main purpose is to pass a bar or rod of similar dimension.

Concrete utility poles are commonly constructed by a rotary spin cast process using a cylinder-shaped mold that is divided lengthwise into two halves, each having a semi-circular cross-section. The mold will usually have holes running throughout its length into which hole-forming plugs can be mounted and secured. After laying down a steel skeleton that usually includes high tension steel strands, rebar rods, and circular rings, a variety of plugs and other hole-formers will be mounted in a number of positions along the mold where it is expected that holes of that size and shape will be desired in the finished pole. The plugs or hole-formers will have at least a minimum length that extends from the outside surface to the hollow core, to ensure that the hole formed reaches the core and is not blocked by concrete. Generally, many more such holes are created than are likely to be immediately needed. As noted, this provides the user with maximum flexibility when configuring the pole for use in the field. It is not uncommon to create 50-100 holes in a single pole, for example.

When the metal skeleton and various plugs are in place, the interior space is approximately half-filled with liquid cement and the two halves of the mold are bolted together. The mold is then aggressively rotated or spun, creating a centrifugal force that drives the cement to the outside, where it forms the wall of the pole and leaves a hollow core. When the spinning is complete and the cement sets, the screws holding the plugs in place are removed and the mold is opened. The finished concrete pole is then removed from the mold, and the plugs are removed from the pole.

In the past, mold plugs have been constructed using a variety of different materials and configurations. However, the various mold plugs attempted have experienced a number of practical difficulties. For example, plugs made of steel become scratched and pitted with use, which causes concrete to stick to the plug surface. This makes the plugs harder to remove, slowing down production, and the holes that are produced are uneven and rough.

In order to overcome the sticking problems of steel plugs, application of grease and various rubber compounds over the steel have been tried. However, applying a grease or oil coating is undesirable in that it stains the concrete. In another approach, a thin rubber cover very similar to a condom is deployed over a steel plug. A separate plastic washer is inserted at the base, held in place by a screw, to maintain the outer edges of the hole clean and neat. This method however requires a great deal of set-up time, as large numbers of the rubber-covered plugs need to be pre-assembled beforehand. Inserting and keeping track of the plastic washers is another complication. Further, the thin rubber cover can disintegrate or tear apart during manufacture, leaving bits of rubber in the hole that must be manually cleaned out when the plugs are removed. Attempts have also been made to use plugs constructed of softer materials. However, such plugs often bend during spinning, particularly if the plugs happen to contact the metal skeleton. This can produce a hole that is similarly bent, and therefore unusable.

Unless these and other practical problems associated with this technology are resolved, the manufacture of concrete poles having a useful number of pre-formed holes will continue to be a costly and difficult process.

### SUMMARY OF THE INVENTION

What is desired is a hole forming plug which overcomes one or more of the problems associated with the current plugs used in the rotary or spin casting process to make concrete poles.

Preferably, the plug is easily secured to the mold used in the spin casting process, and maintains the desired hole size and shape during spinning, even if it contacts the metal skeleton. The plug will also preferably be easily, quickly, and cleanly removable from the finished concrete pole. It would also be preferable for the holes produced by the plug to be clean and uniform, without rough or jagged edges, and for the user to be able to easily select an appropriate plug to produce a hole of a desired shape and size. The plug should also preferably have as few components as possible, be a single unit to keep handling costs relatively low, and be easily manufactured from low-cost materials using well-known manufacturing techniques.

According to one aspect of the present invention, there is provided a mold plug for use in a mold, said mold being used in a rotary concrete casting process to make a cast article, the mold plug comprising:

(a) a rigid internal core having an internal engagement means to secure the plug in the mold during casting and to facilitate removal of the plug from the cast article after casting is complete; and

(b) a pliable external cover on said internal core, said external cover having a surface adapted to not bond with concrete, and having a predetermined size and shape;

wherein, when said mold plug is removed from said cast article after said casting is complete, a hole of a predetermined size and shape is left in said cast article.

According to another aspect of the present invention, there is provided a method of embedding holes in a concrete pole produced by a rotary concrete casting process, said method comprising:

(a) providing a mold plug having a rigid internal core, the internal core having an internal engagement means to secure the plug in the mold during casting and to facilitate removal of the plug after casting is complete, the mold plug also having a pliable external cover on said internal core, the external cover having a surface adapted to not bond with concrete, and having a predetermined size and shape;

(b) securing at least one mold plug in a mold used in said rotary concrete casting process by said internal engagement means;

(c) completing said concrete casting process;

(d) unsecuring said at least one mold plug from said mold and removing said cast concrete pole from said mold;

(e) inserting a plug removal tool into said internal engagement means of said at least one mold plug, and removing said mold plug from said concrete pole; and

(f) repeating step (e) until all of said at least one mold plugs are removed from said concrete pole;

wherein, when each of said at least one mold plug is removed from said concrete pole after said casting is complete, a hole of a predetermined size and shape is left in said pole.

### BRIEF DESCRIPTION OF THE DRAWINGS

Reference will now be made, by way of example only, to drawings illustrating the preferred embodiments of the invention, in which:

FIG. 1 is a side cross-sectional view of the hole forming plug of the present invention;

FIG. 2 is a perspective view of a plug of FIG. 1 showing a bottom of the plug and a bolt available to thread with the threaded cavity in the plug;

FIG. 3 is a perspective view of the internal core of the plug of FIG. 1;

FIG. 4 is a view of a plug removal tool and the plug of FIG. 1 embedded in a concrete pole;

FIG. 5 is a perspective view of several hole forming plugs of the present invention, showing plugs of different sizes and shapes;

FIG. 6 is a perspective view of the plugs of the present invention installed in and being attached to a mold used for spin-casting of a concrete pole;

FIG. 7 is a view of the mold of FIG. 6 being spun to form a concrete pole; and

FIG. 8 is a cross-sectional view of a finished concrete pole showing holes formed by the mold plugs of the present invention, mold plugs yet to be removed, and a worker removing a mold plug.

### DETAILED DESCRIPTION OF THE PREFERRED EMBODIMENTS

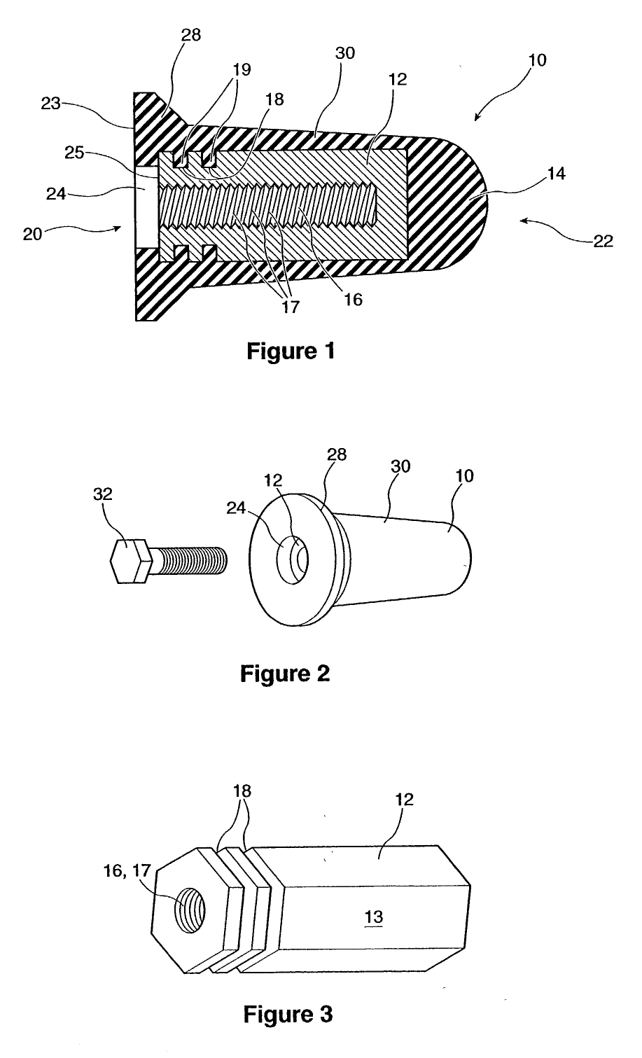

The hole forming plug or mold plug of the present invention is shown in a side cross-sectional view in FIG. 1 and generally designated as 10. The mold plug 10 generally comprises an internal core 12 and external cover 14. The internal core 12 includes an internal engagement means in the form of a threaded cavity 16 having threads 17, and surface features in the form of grooves 18. The external cover 14 has an open or bottom end 20 and a closed or top end 22. It can be seen that the internal core 12 is oriented within the external cover 14 so that the internal engagement means or threaded cavity 16 is accessible through the open end 20. In the preferred embodiment of FIG. 1 there is shown a gap or space 24 at the front end 20 between a bottom edge 23 of the external cover 14 and a bottom edge 25 of the internal core 12. As shown in FIG. 1, in the preferred embodiment the external cover 14 has a base section 28 and a tubular section 30, where the base 28 is wider than the tubular section 30.

FIG. 2 shows a perspective view of the plug 10 generally looking in from the bottom end 20, in which the gap 24 and internal core 12 can be seen. A threaded bolt 32 is shown adjacent to the open end 20. It can be seen that the bolt 32 can be inserted into the open end 20 of the plug 10 and be threaded or screwed into the threads 17 of the threaded cavity 16 to form a secure connection. It can be appreciated therefore that the threaded cavity 16 is sized and shaped to receive a threaded bolt 32 having a compatible size and shape. It can also be appreciated that instead of a bolt 32, a screw or other threaded device could also be used to secure the connection with the plug 10.

The mold plug 10 of the present invention attaches to a mold used in a rotary or spin concrete casting process to make a cast article such as a concrete utility pole. It will be appreciated that the mold plug 10 occupies space that would otherwise be filled by concrete, and therefore, when the mold plug 10 is removed from the cast article after the casting is complete, a hole of a predetermined size and shape is left in the cast article.

FIG. 3 shows the internal core 12 separate from the external cover 14. It can be seen that in the preferred embodiment the internal core 12 is constructed from a solid block of material having an outer surface 13. The threaded cavity 16 can be formed by drilling or boring through the center of the internal core 12, and the grooves 18 can be formed by cutting into the outer surface 13. The internal core 12 is preferably rigid so that the mold plug 10 can maintain its overall shape during the casting process. For example, high tension steel strands and other strong rods or fibers are often used to form a steel skeleton or internal structure in concrete casting, including the casting of concrete utility poles. When the mold plug 10 is inserted in the mold used for casting the plug may abut or otherwise contact the steel structure. Pressure from the steel structure against the plug 10, particularly when the mold is spinning during the casting process, could cause the plug 10 to be re-directed, misaligned, or bent away from a straight shape. In order to withstand this pressure the internal core 12 is preferably constructed to be rigid and strong, so that the mold plug 10 will remain stiff and aligned.

Therefore, in the preferred embodiment the internal core 12 is constructed from high-strength steel. Besides providing adequate rigidity and strength, steel has the advantage of being relatively inexpensive, lightweight, and easy to work with to produce the threaded cavity 16 and grooves 18. It will be appreciated that other materials that provide similar advantages, such as other metals or rigid plastics, may also be used. Similarly, the internal core 12 could be constructed from multiple pieces of material joined together, as long as the internal core 12 that is formed is rigid and strong.

Also, since the internal core 12 is inside the external cover 14, the internal core 12 preferably extends over a sufficient portion of the length of the external cover 14 so that the mold plug 10 maintains an overall stiffness and rigidity. This length may vary for different plug sizes, but preferably is at least half the length of the cover 14. As shown in FIG. 1, the internal core 12 will more preferably extend between ⅔ or ¾ the length of the external cover 14.

The internal engagement means 16 in the internal core 12 secures the plug 10 in the mold during casting, and facilitates removal of the plug 10 from the cast article after casting is complete. In the preferred embodiment, this is achieved by using a threaded cavity as the internal engagement means, where the threaded cavity 16 extends for at least a portion of the length of the internal core 12. The threaded cavity 16 allows the plug 10 to be secured using the extremely common and convenient threaded or screw connection. As already shown in FIG. 2, the mold plug can be secured by simply threading the threaded bolt 32 into the threaded cavity 16. Removing the plug 10 from the mold by threading in the reverse direction is similarly easily achieved, particularly when a power screwdriver is used.

The threaded cavity 16 similarly facilitates removal of the plug 10 from the cast article. The bolt 32 can be screwed in partially such that it is engaged with the plug 10, but its head is available to be gripped, pulled, or pried. Having thus formed a secure connection, the mold plug 10 can be readily pulled or pried out of the cast article by pulling on the bolt 32 or other threaded device, which in turn pulls on the plug 10 via the threads 17.

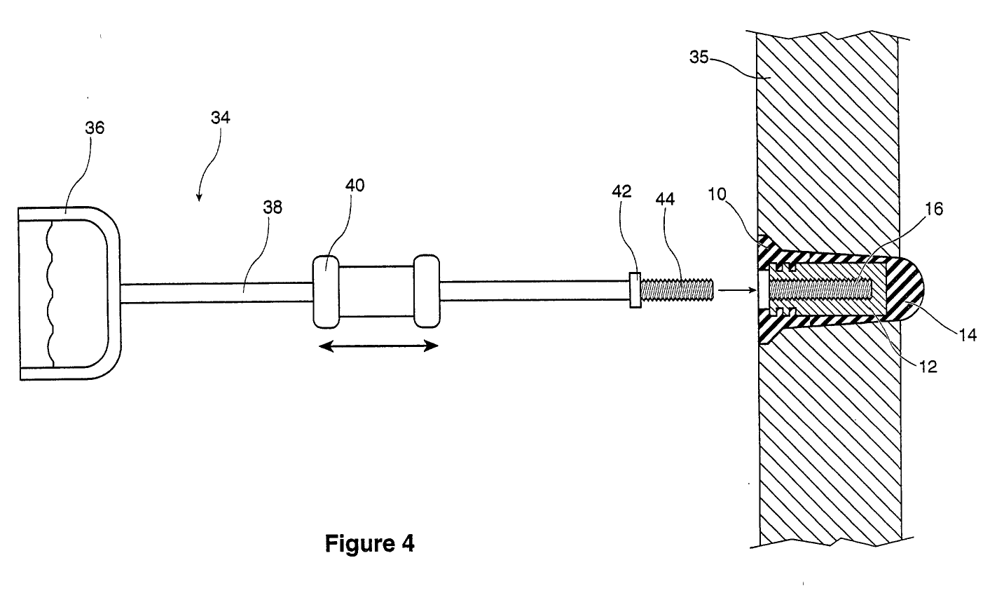

The mold plug 10 may also be removed with a specialized removal tool. An example of a plug removal tool 34 is shown in FIG. 4, which shows the tool 34 poised to enter the threaded cavity 16 of the mold plug 10 embedded in a finished concrete utility pole 35. The plug removal tool 34 comprises a handle 36, a shaft 38, a sliding hammer 40, a stopper 42, and a threaded tip 44. The threaded tip 44 is adapted to thread into threaded cavity 16. The sliding hammer 40 is a weighted block that slides freely along the shaft 38. When forcefully pulled back, the hammer 40 may impact the handle 36 with sufficient force to jar the plug 10 out of the pole 35. While the plug removal tool 34 is a special purpose threaded device optimized to remove the plug 10 of the present invention, it can be appreciated that, as already noted, other methods are readily available that require only such easily accessible items as a threaded bolt 32 and crowbar, pliers, or other handheld tool.

It can be appreciated that other embodiments of the internal engagement means 16 other than the preferred threaded cavity are also possible, as long as they enable the plug 10 to be readily and conveniently secured to and removed from the mold, and provide for convenient removal of the plug 10 from the cast article.

The surface features 18 on the outer surface of the internal core 12 securely attach the internal core 12 to the external cover 14. Since removal of the plug 10 from the cast article is effected through engagement with the threaded cavity 16, if the elements are not securely attached the internal core 12 may be pulled out and separated from the external cover 14, leaving the external cover 14 inside the cast article.

In the preferred embodiment, grooves 18 are cut out of the surface of the internal core 12. It will be appreciated that it is relatively simple to manufacture cores 12 having the preferred grooves 18. It will also be appreciated that other embodiments of surface features may also function adequately. The external cover 14 is sized and shaped, in at least a portion, to form ridges 19 that fit within the space cut out by the grooves 18, thus gripping the core 12 and forming a secure attachment or tight fit. It has been found that grooves having a depth of approximately 1/16-⅛ inches provide adequate results. The grooves 18 are preferably constructed closer to the bottom edge 25 of the internal core 12, or closer to the open end 20 rather than the closed end 22 of the plug 10. This avoids bulging at the front of the external cover 14, which may occur when the grooves 18 are placed closer to the closed end 22. In general, it has been found that longer plugs, approximately one or more inches in length, benefit from two grooves 18 closer to the bottom edge 25 of internal core 12. Shorter plugs may function adequately with a single groove 18, located up to as far as the middle of internal core 12.

It can be appreciated that the number of grooves 18 and their location on internal core 12 can vary depending on the size and shape of the plug 10, as long as they function to provide a secure attachment or connection between the core 12 and cover 14. As noted, in most cases one or two grooves 18 located between the bottom edge 25 and middle of internal core 12 provide adequate results.

The internal core 12 shown in FIG. 3 is hexagonal in shape. It can be appreciated that the internal core 12 may be constructed with a different number of sides, or have a cylindrical shape. However, the internal core 12 is preferably multi-sided rather than cylindrical, since the edges created between adjacent sides resist the torque created when a bolt 32 or other device is threaded into the threaded cavity 16. The hexagonal shape has provided adequate results in this regard, and is also a convenient shape to use because hexagonal shaped steel rods are a commonly available stock item.

The material or materials used to form the external cover 14, or at least the outer surface of the cover 14, is preferably adapted to not bond with concrete. The use of material having this property will help reduce any sticking that may occur between the mold plug 10 and the concrete pole. Sticking is undesirable as it slows down the workers removing the plugs, and often creates holes with jagged or rough edges since pieces of concrete stuck to the cover 14 may get pulled out of the hole. In the preferred embodiment, rubber is used to form the external cover 14 and has produced adequate results. In particular, natural rubber is preferred over clay-based, neoprene, and other types of synthetic rubber because of its superior concrete resistance characteristics.

The material used for the external cover 14 is also preferably pliable, supple, or yielding to some extent. As noted, the internal core 12 under the external cover 14 provides rigidity and firmness to the mold plug. At the same time, the pliable external cover 14 provides the outer surface of the plug 10 with some “give” or yield, which is useful when the plug 10 contacts a high tension steel wire or other part of the skeleton structure. The steel strands may rest against or indent the softer cover material. In this way, the combination of a rigid internal core 12 with a pliable external cover 14 enables the plug 10 to maintain a clean, straight hole while at the same time minimizing the extent to which the skeleton structure is bent or diverted from its path.

As shown in FIG. 1, the external cover 14 is preferably constructed as a single piece or body, and has a predetermined size and shape. The cover 14 is sized and shaped to bond with the surface of the internal core 12. As noted, this includes at least a portion of the cover 14 in the form of the ridges 19, adapted to fit within the grooves 18 to form a secure and tight connection with the internal core 12. It also includes the external cover 14 being sized and shaped so as to surround almost the entire outer surface 13 of the core 12. In particular, in the preferred embodiment the cover 14 completely covers the core 12 at the top end 22 and at least partly covers the bottom end 20, so as to abut the bottom end 20, thus holding the core 12 securely within the cover 14.

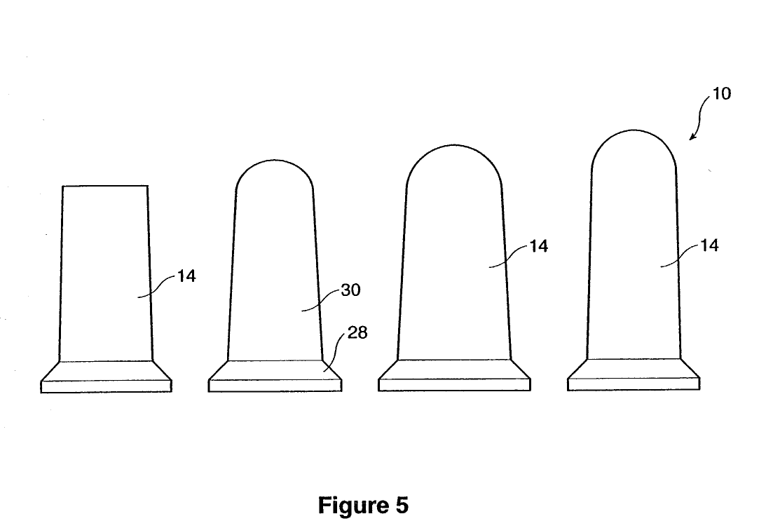

FIG. 5 shows a representative sample of mold plugs 10 having a variety of sizes and shapes. It can be appreciated that by varying the length and width of the tubular section 30 and base section 28 of the external cover 14, the mold plugs 10 can can be made to a predetermined size appropriate to form a hole of a particular size or width within a concrete article having an outer wall of a particular thickness. The length of the cover 14 or height of the overall mold plug 10 should preferably be at least slightly longer than the concrete wall thickness so that a concrete barrier does not form at the interior end of the hole. As well, the shape of the mold plug 10 can be varied by modifying the shape of the external cover 14. For example, as shown in FIG. 5 the closed end 22 of the plug can be round or flat. As the size and shape of the external cover 14 is varied, the internal core 12 will preferably be similarly adjusted to a corresponding size and shape to provide the necessary internal firmness and rigidity.

By way of example, where it is desired to create a hole sufficiently large to clear a rod or bar ½ inch in diameter in a concrete pole having 2 inch thick outer walls, adequate results have been obtained using a plug 10 approximately 2 ¼″ to 2 ½″ high, ¾″ wide at the top end 22, with a base section 28 that is 1 ¼″ wide and a core 12 about ⅝″ wide. Of course it can be appreciated that a plug 10 having other sizes for these parameters could also be used and provide adequate results.

It can also be seen from the figures that the tubular section 30 preferably tapers slightly from the bottom end 20 towards the top end 22 of the plug 10. This taper or draft angle assists with removal of the plugs 10 from the mold, since once the plug 10 is initially pulled out, the width of the plug 10 at any point along the hole will tend to be narrower than the hole itself at that point.

It will be appreciated that the wider base section 28 of the plug 10 creates a shallow depression in the concrete around the resulting hole. It has been found that this format is considered by many to be more visually appealing, particularly where there is chipping of the concrete in or around the rim of the hole.

It can be appreciated that the mold plugs 10 of the present invention may be manufactured using well-known production techniques. The internal core 12, if made from steel or another metal, may be cast to a desired height, width, and shape. As noted, the preferred hexagonal steel cores are readily available in a variety of sizes as a stock item. The core block can be machined to form the threaded cavity 16 and grooves 18. The mold plug 10 can then be completed by injecting rubber into a mold in which the internal cores 12 have been securely positioned. The mold will have a predetermined size and shape corresponding to the desired hole size. The pliable external covers 14 created by the rubber injection molding will bond to the internal cores 12 as described above, by wrapping around the surface 13 so as to hold the core 12 securely within, and by forming ridges 19 that fit within the grooves 18. It can be appreciated that other methods of manufacture may also be used and provide adequate results.

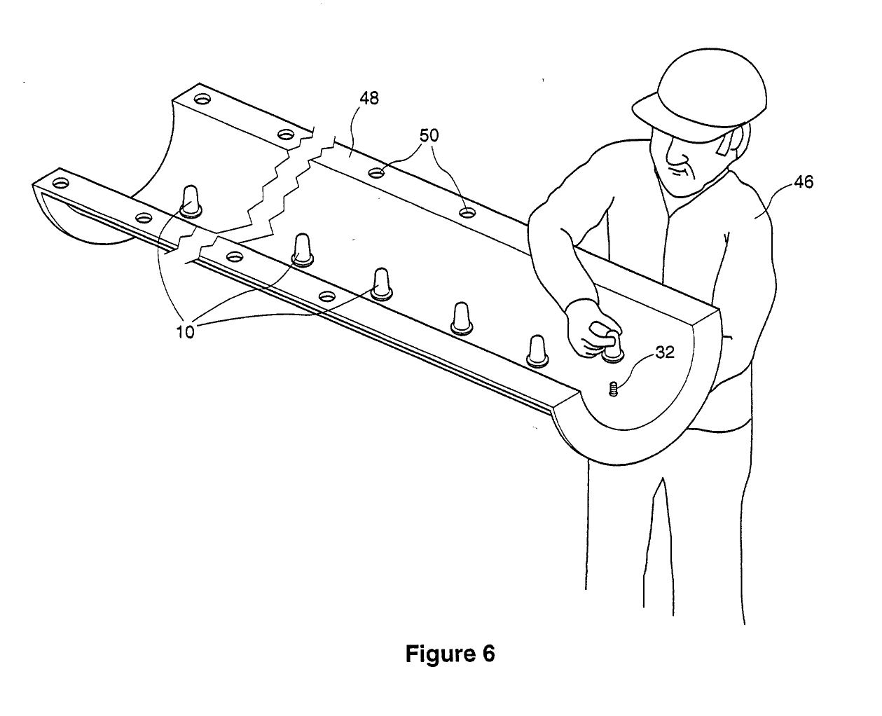

The operation of the mold plug 10 of the present invention, to enable a method of embedding holes in a concrete pole or other cast article produced by a rotary concrete casting process, can now be described. FIG. 6 shows a worker 46 installing or securing the mold plugs 10 in a mold 48 used for a rotary concrete casting process, such as for a utility pole. The mold 48 includes two identical semi-circular halves, of which one is shown in FIG. 6. Plugs 10 would generally be inserted into the other half mold as well, so that the plugs are directly opposed, 180 degrees apart. The two mold halves 48 attach to each other through bolts inserted through mold apertures 50. For clarity FIG. 6 does not show the steel skeleton that is also installed in the mold 48 during manufacturing.

Installation is accomplished by inserting the threaded bolts 32 through holes in the mold 48, and threading the bolt 32 into the threaded cavity 16 of the mold plug 10. It can be appreciated that since the cover 14 and the core 12 are bonded together, the plugs 10 function as one piece and are easy to handle and work with. The plugs do not have to be prepared prior to installation, and are easily attached to and removed from the mold 48 due to the threaded cavity 16.

It can be appreciated that prior to installation of the plugs 10 in FIG. 6, a user would select a desired hole size and shape for the finished pole. Then, a plug 10 having a predetermined size and shape that corresponds with the desired hole size and shape would be used. The length of the selected plug 10 should preferably be at least slightly longer than the expected concrete wall thickness of the pole to be cast.

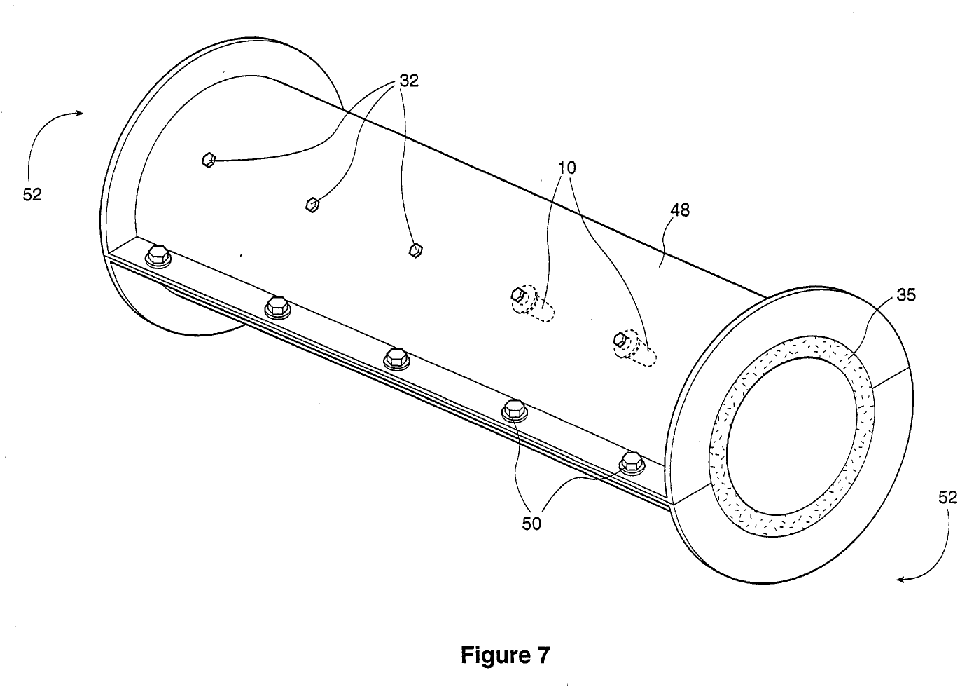

FIG. 7 shows the complete mold 48, with the two halves joined at mold apertures 50. Concrete 35 in liquid form has been poured into the mold 48 and the concrete casting process is carried out by spinning or rotating the mold 48, as indicated by arrows 52. The spinning flings the concrete 35 to the inner surface of the mold 48 where, upon hardening, the walls of the concrete pole formed from the mold 48 are cast. The threaded screws 32 holding the plugs 10 can be seen in this view, and two of the plugs 10 are shown in hidden view. It can be appreciated that the rigid internal core 12 maintains the form of the mold plug 10 even during the rotary casting process. When the concrete 35 is cured, the threaded bolts 32 are removed. The bolts are removed from mold apertures 50 and the finished concrete pole 35 is removed from the mold 48.

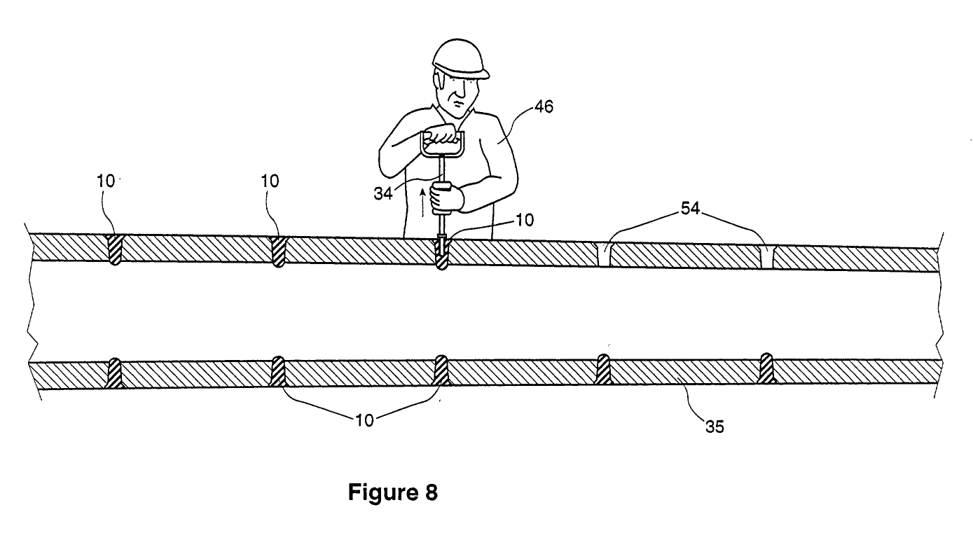

FIG. 8 shows a cross-sectional view of the finished pole 35. The series of plugs 10 can be seen embedded in the concrete walls. Two holes 54 are shown where the plugs 10 have been removed. The holes 54 have a predetermined size and shape that corresponds with the predetermined size and shape of the mold plugs 10 selected for the concrete casting. The worker 46 inserts the threaded tip 44 of the plug removal tool 34 into the first few threads 17 of the threaded cavity 16 of the plug 10, to form a secure attachment. Then the worker slides the hammer 40 up so that it impacts the handle 36, providing a force that causes the plug 10 to pop out of the pole. As noted, other means of removing the plug 10 such as inserting a bolt 32 and pulling or prying out the plug 10 with a crowbar or pliers, or otherwise applying an outward force, can also be used. After removing the plug 10 the process is repeated until the remaining plugs are removed.

It will be appreciated by those skilled in the art that the foregoing description was in respect of preferred embodiments and that various alterations and modifications are possible within the broad scope of the appended claims without departing from the spirit of the invention. For example, while reference is made to a plug removal tool that threads into the internal engagement means to form a secure attachment, the internal core could be constructed to have an undercut or cut-away portion. The plug removal tool could then be secured to the internal core through an outwardly projecting hook rather than a threaded connection. Various other modifications will be apparent to those skilled in the art but are not described in any further detail herein.

The embodiments of the invention in which an exclusive property or privilege is claimed are defined as follows:

1. A mold plug for use in a mold, said mold being used in a rotary concrete casting process to make a cast article, the mold plug comprising:
(a) a rigid internal core having an internal engagement means to secure the plug in the mold during casting and to facilitate removal of the plug from the cast article after casting is complete; and
(b) a pliable external cover on said internal core, said external cover having a surface adapted to not bond with concrete, and having a predetermined size and shape;
wherein, when said mold plug is removed from said cast article after said casting is complete, a hole of a predetermined size and shape is left in said cast article.

2. The mold plug according to claim 1, wherein said internal core further includes surface features to securely attach said internal core to said external cover.

3. The mold plug according to claim 2, wherein said surface features comprise grooves on a surface of said internal core.

4. The mold plug according to claim 1, wherein said internal core and external cover each have a length, and the length of said internal core is at least half of the length of said external cover.

5. The mold plug according to claim 1, wherein said internal core has a length, and said internal engagement means comprises a threaded cavity extending for at least a portion of the length of said internal core.

6. The mold plug according to claim 1, wherein said internal engagement means is adapted to receive a plug removal tool.

7. The mold plug according to claim 1, wherein said internal core is constructed from metal or rigid plastic.

8. The mold plug according to claim 1, wherein said internal core is multi-sided in shape.

9. The mold plug according to claim 1, wherein said internal core has a surface, and said pliable external cover is sized and shaped to bond to said surface of said internal core.

10. The mold plug according to claim 9, wherein said pliable external cover has an open end and a closed end, and said internal core is oriented within said external cover so that said internal engagement means of said internal core is accessible through said open end.

11. The mold plug according to claim 3, wherein at least a portion of said pliable external cover is sized and shape to fit within said grooves on said surface of said internal core, to form a secure attachment of said external cover with said internal core.

12. The mold plug according to claim 1, wherein said predetermined shape of said pliable external cover includes a base section and a tubular section, and said base section is wider than said tubular section.

13. The mold plug according to claim 1, wherein said pliable external cover is constructed from natural rubber.

14. The mold plug according to claim 1, wherein said cast article has a wall thickness, and said pliable external cover has a length that is longer than said wall thickness.

15. A method of embedding holes in a concrete pole produced by a rotary concrete casting process, said method comprising:
(a) providing a mold plug having a rigid internal core, the internal core having an internal engagement means to secure the plug in the mold during casting and to facilitate removal of the plug after casting is complete, the mold plug also having a pliable external cover on said internal core, the external cover having a surface adapted to not bond with concrete, and having a predetermined size and shape;
(b) securing at least one mold plug in a mold used in said rotary concrete casting process by said internal engagement means;
(c) completing said concrete casting process;
(d) unsecuring said at least one mold plug from said mold and removing said cast concrete pole from said mold;
(e) inserting a plug removal tool into said internal engagement means of said at least one mold plug, and removing said mold plug from said concrete pole; and
(f) repeating step (e) until all of said at least one mold plugs are removed from said concrete pole;
wherein, when each of said at least one mold plug is removed from said concrete pole after said casting is complete, a hole of a predetermined size and shape is left in said pole.

16. A method of embedding holes in a concrete pole according to claim 15, wherein said internal engagement means is a threaded cavity and said plug removal tool includes a slide hammer, a handle, and a threaded tip, and said step of inserting a plug removal tool in step (e) comprises threading said tip into said threaded cavity to form a secure attachment, and said step of removing said mold plug in step (e) comprises sliding said slide hammer against said handle to provide a force pulling said mold plug out of said concrete pole.

17. A method of embedding holes in a concrete pole according to claim 15, further including the steps of:
(a) selecting a desired hole size and shape; and
(b) selecting at least one mold plug having a predetermined size and shape corresponding with said desired hole size and shape.
